(19) United States
(12) Patent Application Publication
(10) Pub. No.: US 2017/0338620 A1
(43) Pub. Date: Nov. 23, 2017

(54) LASER DEVICE

(71) Applicant: Gigaphoton Inc., Tochigi (JP)

(72) Inventors: Masaki ARAKAWA, Oyama-shi (JP); Kouji KAKIZAKI, Oyama-shi (JP); Osamu WAKABAYASHI, Oyama-shi (JP)

(73) Assignee: Gigaphoton Inc., Tochigi (JP)

(21) Appl. No.: 15/669,218

(22) Filed: Aug. 4, 2017

Related U.S. Application Data
(63) Continuation of application No. PCT/JP2015/059275, filed on Mar. 25, 2015.

(51) Int. Cl. H01S 3/23; H01S 3/097; H01S 3/038; H01S 3/225; H01S 3/034

(52) U.S. Cl. CPC H01S 3/2308; H01S 3/2316; H01S 3/225; H01S 3/034; H01S 3/038; H01S 3/097

(57) ABSTRACT

A laser device may include: a master oscillator including a first laser chamber, a first pair of discharge electrodes provided in the first laser chamber, and an optical resonator, the master oscillator being configured to output a laser beam; a first amplifier including a second laser chamber provided in an optical path of the laser beam outputted from the master oscillator and a second pair of discharge electrodes provided in the second laser chamber at a first gap distance, the first amplifier being configured to amplify the laser beam; and a first beam-adjusting optical system provided in an optical path of the laser beam between the master oscillator and the first amplifier, the first beam-adjusting optical system being configured to adjust the laser beam outputted from the master oscillator such that a beam width of the laser beam entering the first amplifier measured in a direction of electric discharge between the second pair of discharge electrodes is substantially equal to the first gap distance between the second pair of discharge electrodes.

### TECHNICAL FIELD

The present disclosure relates to a laser device.

### BACKGROUND ART

A laser annealing apparatus may apply a pulsed laser beam on an amorphous silicon film formed on a substrate. The pulsed laser beam may be emitted from a laser system such as an excimer laser system. The pulsed laser beam may have a wavelength of ultraviolet light region. Such pulsed laser beam may reform the amorphous silicon film to a poly-silicon film. The poly-silicon film can be used to form thin film transistors (TFTs). The TFTs may be used in large-sized liquid crystal displays.

Patent Document 1

Japanese Patent Application Publication No. 2009-277977 A

Patent Document 2

U.S. Pat. No. 8,803,027 B

Patent Document 3

Japanese Patent No. 4818871 B

Patent Document 4

Japanese Patent No. 5376908 B

### SUMMARY

A laser device according to an aspect of the present disclosure may include: a master oscillator including a first laser chamber, a first pair of discharge electrodes provided in the first laser chamber, and an optical resonator, the master oscillator being configured to output a laser beam; a first amplifier including a second laser chamber provided in an optical path of the laser beam outputted from the master oscillator and a second pair of discharge electrodes provided in the second laser chamber at a first gap distance, the first amplifier being configured to amplify the laser beam; and a first beam-adjusting optical system provided in an optical path of the laser beam between the master oscillator and the first amplifier, the first beam-adjusting optical system being configured to adjust the laser beam outputted from the master oscillator such that a beam width of the laser beam entering the first amplifier measured in a direction of electric discharge between the second pair of discharge electrodes is substantially equal to the first gap distance between the second pair of discharge electrodes.

A laser device according to another aspect of the present disclosure may include: a master oscillator including a first laser chamber, a first pair of discharge electrodes provided in the first laser chamber, and an optical resonator, the master oscillator being configured to output a laser beam; a first amplifier including a second laser chamber provided in an optical path of the laser beam outputted from the master oscillator and a second pair of discharge electrodes provided in the second laser chamber, the first amplifier being configured to amplify the laser beam; and a first beam-adjusting optical system provided in an optical path of the laser beam between the master oscillator and the first amplifier, the first beam-adjusting optical system being configured to adjust the laser beam outputted from the master oscillator, the first beam-adjusting optical system including a first optical element with a positive power and a second optical element with a positive or negative power provided downstream from the first optical element in the optical path of the laser beam.

A laser device according to another aspect of the present disclosure may include: a master oscillator including a first laser chamber, a first pair of discharge electrodes provided in the first laser chamber, and an optical resonator, the master oscillator being configured to output a laser beam; a first amplifier including a second laser chamber provided in an optical path of the laser beam outputted from the master oscillator and a second pair of discharge electrodes provided in the second laser chamber, the first amplifier being configured to amplify the laser beam; and a first beam-adjusting optical system provided in an optical path of the laser beam between the master oscillator and the first amplifier, the first beam-adjusting optical system being a both-side telecentric optical system.

### BRIEF DESCRIPTION OF DRAWINGS

Exemplary embodiments of the present disclosure will be described below as mere examples with reference to the appended drawings.

FIG. 1A schematically shows a configuration of a laser device according to a comparative example.

FIG. 1B shows a power amplifier PA shown in FIG. 1A as viewed in a direction parallel to a direction of electric discharge between a pair of discharge electrodes.

FIG. 2A shows a beam profile in a cross section of a beam at line IIA in FIG. 1A.

FIG. 2B shows a beam profile in a cross section of the beam at line IIB in FIG. 1A.

FIG. 2C shows a beam profile in a cross section of the beam at line IIC in FIG. 1A.

FIG. 3A schematically shows a configuration of a laser device according to a first embodiment of the present disclosure.

FIG. 3B schematically shows the configuration of the laser device according to the first embodiment of the present disclosure.

FIG. 4A shows a beam profile in a cross section of a beam at line IVA in FIG. 3A.

FIG. 4B shows a beam profile in a cross section of the beam at line IVB in FIG. 3A.

FIG. 4C shows a beam profile in a crass section of the beam at line IVC in FIG. 3A.

FIG. 5A shows a beam-adjusting optical system 40a as viewed in a −V direction as a first example of a beam-adjusting optical system shown in FIG. 3A.

FIG. 5B shows the beam-adjusting optical system 40a as viewed in a −H direction.

FIG. 6A shows a beam-adjusting optical system 40b as viewed in the −V direction as a second example of the beam-adjusting optical system shown in FIG. 3A.

FIG. 6B shows the beam-adjusting optical system 40b as viewed in the −H direction.

FIG. 7A shows a beam-adjusting optical system 40c as viewed in the −V direction as a third example of the beam-adjusting optical system shown in FIG. 3A.

FIG. 7B shows the beam-adjusting optical system 40c as viewed in the −H direction.

FIG. 8A shows a beam-adjusting optical system 40d as viewed in the −V direction as a fourth example of the beam-adjusting optical system shown in FIG. 3A.

FIG. 8B shows the beam-adjusting optical system 40d as viewed in the −H direction.

FIG. 9A shows a beam-adjusting optical system 40e as viewed in the −V direction as a fifth example of the beam-adjusting optical system shown in FIG. 3A.

FIG. 9B shows the beam-adjusting optical system 40e as viewed in the −H direction.

FIG. 10A schematically shows a configuration of a laser device according to a second embodiment of the present disclosure.

FIG. 10B schematically shows the configuration of the laser device according to the second embodiment of the present disclosure.

FIG. 11A shows a beam profile in a cross section of a beam at line XIA in FIG. 10A.

FIG. 11B shows a beam profile in a cross section of the beam at line XIB in FIG. 10A.

FIG. 11C shows a beam profile in a cross section of the beam at line XIC in FIG. 10A.

FIG. 12A schematically shows a configuration of a laser device of a modified example according to the second embodiment of the present disclosure.

FIG. 12B schematically shows the configuration of the laser device of the modified example according to the second embodiment of the present disclosure.

FIG. 13 schematically shows a configuration of a laser device according to a third embodiment of the present disclosure.

FIG. 14A schematically shows an optical arrangement of the laser device shown in FIG. 13.

FIG. 14B schematically shows an optical arrangement of a laser device of a first modified example according to the third embodiment of the present disclosure.

FIG. 14C schematically shows an optical arrangement of a laser device of a second modified example according to the third embodiment of the present disclosure.

### DESCRIPTION OF EMBODIMENTS

Contents
1. Outline
2. Laser Device According to Comparative Example
   2.1 Configuration of MOPA Laser
   2.2 Operation of MOPA Laser
   2.3 Problem
3. Laser Device Including Beam-Adjusting Optical System
   3.1 Configuration
   3.2 Operation
   3.3 Effect
   3.4 Others
   3.5 First Example of Beam-Adjusting Optical System
   3.6 Second Example of Beam-Adjusting Optical System
   3.7 Third Example of Beam-Adjusting Optical System
   3.8 Fourth Example of Beam-Adjusting Optical System
   3.9 Fifth Example of Beam-Adjusting Optical System
4. Laser Device Including Both-Side Telecentric Beam-Adjusting Optical System
   4.1 Configuration
   4.2 Operation
   4.3 Effect
   4.4 Others
   4.5 Modified Example of Second Embodiment
5. Laser Device Including Plurality of Power Amplifiers
   5.1 Configuration
   5.2 Operation and Effect
   5.3 Modified Examples of Third Embodiment

Embodiments of the present disclosure will be described below in detail with reference to the drawings. The embodiments described below may represent several examples of the present disclosure and may not intend to limit the content of the present disclosure. Not all of the configurations and operations described in the embodiments are indispensable in the present disclosure. Identical reference symbols may be assigned to identical elements and redundant descriptions may be omitted.

### 1. OUTLINE

A laser annealing apparatus may perform laser annealing by irradiating an amorphous silicon film on a glass substrate with a pulsed laser beam at a predetermined energy density. The pulsed laser beam may be demanded to increase its energy per one pulse for enlarging irradiation area at the predetermined energy density to manufacture larger and larger liquid crystal displays as in recent years. Increasing energy per one pulse may be achieved by using two-chamber system including a master oscillator (MO) and a power amplifier (PA). Such laser device using the two-chamber system may be referred to as a MAPA laser.

The laser beam outputted from the master oscillator may have a positive divergence and thus the diameter of the beam may increase before the beam enters the power amplifier. If the diameter of the beam exceeds a dimension of a discharge space of the power amplifier, a part of the laser beam that does not enter the discharge space of the power amplifier may be wasted. This may cause reduction of efficiency of laser beam generation with the MOPA laser. Such problem may occur if, for example, a discharge space of the master oscillator and a discharge space of the power amplifier is substantially the same in size and the master oscillator and the power amplifier are distanced from each other.

According to one aspect of the present disclosure, a first beam-adjusting optical system provided in an optical path between the master oscillator and the power amplifier may include a first optical element with a positive power and a second optical element with a positive or negative power disposed downstream from the first optical element in the optical path of the laser beam.

According to another aspect of the present disclosure, the first beam-adjusting optical system provided in the optical path between the master oscillator and the power amplifier may be a both-side telecentric optical system.

The first beam-adjusting optical system may adjust the laser beam such that a beam width of the laser beam entering the power amplifier is substantially equal to a gap distance between a pair of discharge electrodes of the power amplifier.

### 2. LASER DEVICE ACCORDING TO COMPARATIVE EXAMPLE

### 2.1 CONFIGURATION OF MOPA LASER

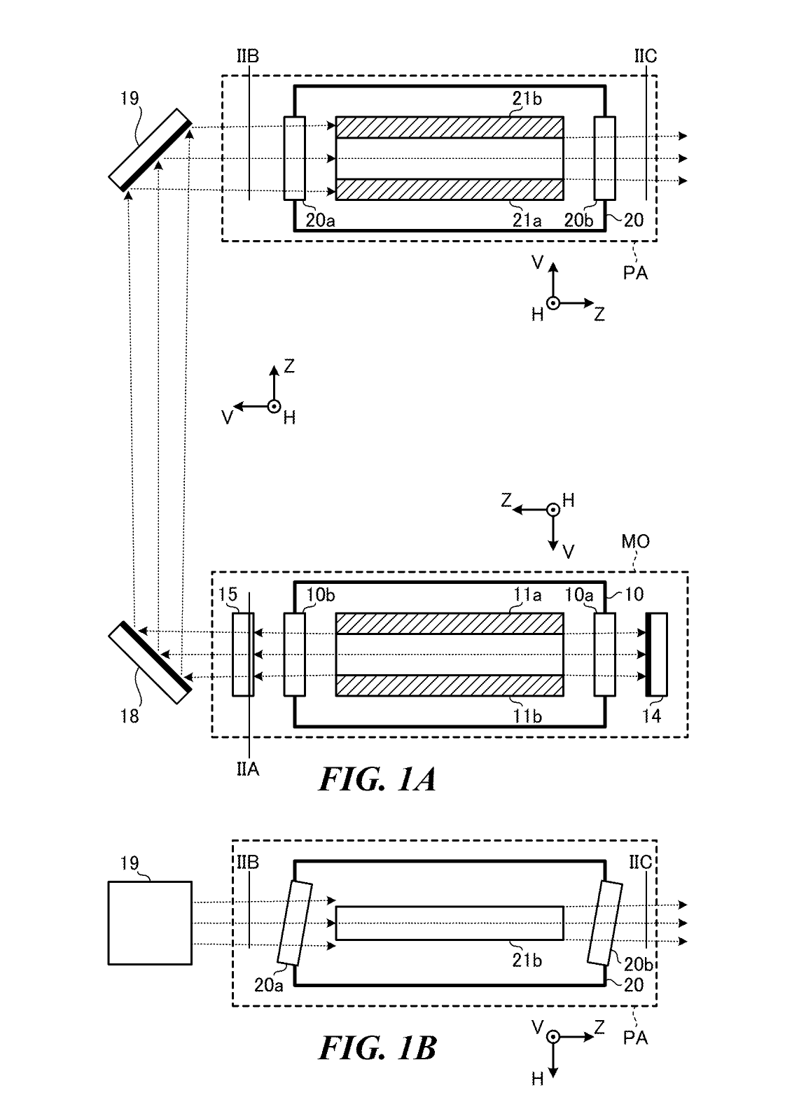

FIG. 1A schematically shows a configuration of a laser device according to a comparative example. This laser device may be a MOPA laser including a master oscillator MO, a power amplifier PA, and a plurality of high-reflective mirrors 18 and 19. FIG. 1A shows a view in a direction perpendicular to a direction of travel of the laser beam and perpendicular to a direction of electric discharge between a pair of discharge electrodes in the master oscillator MO and that in the power amplifier PA. FIG. 1B shows the power amplifier PA shown in FIG. 1A as viewed in a direction parallel to the direction of electric discharge between the pair of discharge electrodes in the power amplifier PA. The direction of travel of the laser beam may be a Z direction. The direction of electric discharge between the pair of discharge electrodes of the master oscillator MO or that in the power amplifier PA may be a V direction. The direction perpendicular to both of the Z direction and the V direction may be an H direction. As the direction of travel is changed by the high-reflective mirror 18 or 19 reflecting the laser beam, the Z direction and the V direction may be changed.

The master oscillator MO may include a first laser chamber 10, a first pair of discharge electrodes 11a and 11b, a rear mirror 14, and an output coupling mirror 15. The first pair of discharge electrodes 11a and 11b may be provided in the first laser chamber 10. The rear mirror 14 and the output coupling mirror 15 may constitute an optical resonator. A discharge space between the first pair of discharge electrodes 11a and 11b may be located between the rear mirror 14 and the output coupling mirror 15. The rear mirror 14 may be a mirror to reflect the laser beam at a high reflectance. The output coupling mirror 15 may be made of a substrate such as CaF₂ crystal to transmit an excimer laser beam and may be coated with a partially-reflective film to reflect the excimer laser beam at a rate in a range from 10% to 40%. The first laser chamber 10 may have windows 10a and 10b at respective ends of the first laser chamber 10.

The high-reflective mirrors 18 and 19 may be disposed such that the pulsed laser beam outputted from the master oscillator MO enters the power amplifier PA as a seed beam.

The power amplifier PA may include a second laser chamber 20 and a second pair of discharge electrodes 21a and 21b. The second pair of discharge electrodes 21a and 21b may be provided in the second laser chamber 20. The second laser chamber 20 may have windows 20a and 20b at respective ends of the second laser chamber 20.

The first laser chamber 10 and the second laser chamber 20 may each store excimer laser gas. The excimer laser gas may include a rare gas such as argon gas, krypton gas or xenon gas, a halogen gas such as fluorine gas or chlorine gas, and a buffer gas such as neon gas or helium gas.

The discharge space between the first pair of discharge electrodes 11a and 11b and the discharge space between the second pair of discharge electrodes 21a and 21b may have substantially the same forms and sizes with each other. A gap distance between the first pair of discharge electrodes 11a and 11b and a gap distance between the second pair of discharge electrodes 21a and 21b may thus be substantially equal to each other.

The windows 10a, 10b, 20a and 20b may each be made of CaF₂ crystal or the like to transmit the excimer laser beam. The windows 10a, 10b, 20a and 20b may each be inclined in the H direction at a Brewster's angle to suppress reflection of the laser beam.

### 2.2 OPERATION OF MOPA LASER

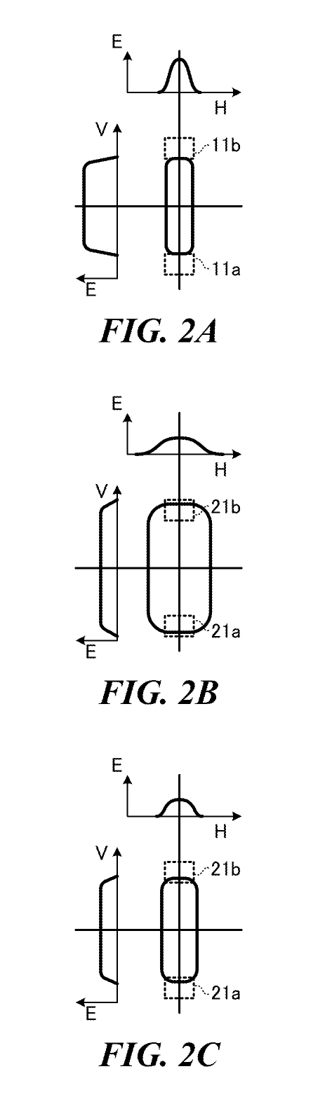

FIG. 2A shows a beam profile in a cross section of the laser beam at line IIA in FIG. 1A. FIG. 2B shows a beam profile in a cross section of the laser beam at line IIB in FIG. 1A. FIG. 2C shows a beam profile in a cross section of the laser beam at line IIC in FIG. 1A.

A power source (not shown) in the master oscillator MO may apply a pulsed high voltage to the first pair of discharge electrodes 11a and 11b. The pulsed high voltage applied to the first pair of discharge electrodes 11a and 11b may cause pulsed electric discharge between the first pair of discharge electrodes 11a and 11b. The laser gas may be excited by energy of the electric discharge and may shift to a high energy level. The excited laser gas may then shift back to a low energy level to emit light having a certain wavelength depending on the difference between the energy levels. In the excimer laser device, this light may include ultra-violet rays. The light generated in the first laser chamber 10 may be emitted from the first laser chamber 10 through the windows 10a and 10b. The light may travel back and forth between the rear mirror 14 and the output coupling mirror 15 constituting the optical resonator to form a standing wave. The light may reciprocate through the discharge space between the first pair of discharge electrodes 11a and 11b and thus be amplified, which causes laser oscillation.

The output coupling mirror 15 may transmit a part of the light generated in the optical resonator. The master oscillator MO may thus output the pulsed laser beam. Here, the beam profile of the output laser beam may have a form as shown in FIG. 2A. The beam profile may have substantially the same size as the size of a cross section of the discharge space between the first pair of discharge electrodes 11a and 11b.

As shown in FIG. 2A, the cross section of the laser beam outputted from the master oscillator MO may have a form relatively long in the direction of electric discharge, namely, in the V direction. The cross section of the laser beam may have a substantially rectangular form. Further, the beam profile in the V direction of the laser beam outputted from the master oscillator MO may have a substantially top-hat distribution having a substantially uniform energy density. Further, the beam profile in the H direction of the laser beam outputted from the master oscillator MO may have a Gaussian distribution having a high energy density around the center of the distribution and having a low energy density around each end of the distribution.

The laser beam, diverging in respective angles of divergence in the H direction and the V direction, may be reflected by the high-reflective mirrors 18 and 19 and then enter the window 20a of the power amplifier PA as the seed beam. The beam profile of the pulsed laser beam entering the window 20a may have a form as shown in FIG. 2B. A part of the laser beam having entered the window 20a may then enter the discharge space between the second pair of discharge electrodes 21a and 21b. However, another part of the laser beam having entered the window 20a may deviate from the discharge space in ±V directions and hit the second pair of discharge electrodes 21a and 21b, without entering the discharge space. Further, still another part of the laser beam having entered the window 20a may deviate from the discharge space in ±H directions without entering the discharge space.

A pulsed high voltage may be applied to the second pair of discharge electrodes 21a and 21b by a power source (not shown) in synchronization with the part of the pulsed laser beam entering the discharge space between the second pair of discharge electrodes 21a and 21b. The pulsed high voltage applied to the second pair of discharge electrodes 21a and 21b may cause pulsed electric discharge between the second pair of discharge electrodes 21a and 21b. The laser gas may be excited due to the electric discharge in the laser gas. As a result, the laser beam passing through the gap between the second pair of discharge electrodes 21a and 21b may be amplified. The laser beam thus amplified may be outputted from the power amplifier PA through the window 20b. The beam profile of the pulsed laser beam outputted from the power amplifier PA may have a form as shown in FIG. 2C. The laser beam outputted through the window 20b may gradually diverge. A beam width in the V direction at the line IIC in FIG. 1A may thus be slightly larger than the gap distance between the second pair of discharge electrodes 21a and 21b.

### 2.3 PROBLEM

If the distance between the master oscillator MO and the power amplifier PA is large, the beam size of the laser beam entering the window 20a of the power amplifier PA may be larger than the size of the cross section of the discharge space of the power amplifier PA. In that case, a part of the laser beam may fail to enter the discharge space of the power amplifier PA and fail to be amplified. This may cause reduction of efficiency of laser beam generation with the MOPA laser.

Embodiments according to the present disclosure are thus explained below.

### 3. LASER DEVICE INCLUDING BEAM-ADJUSTING OPTICAL SYSTEM

### 3.1 CONFIGURATION

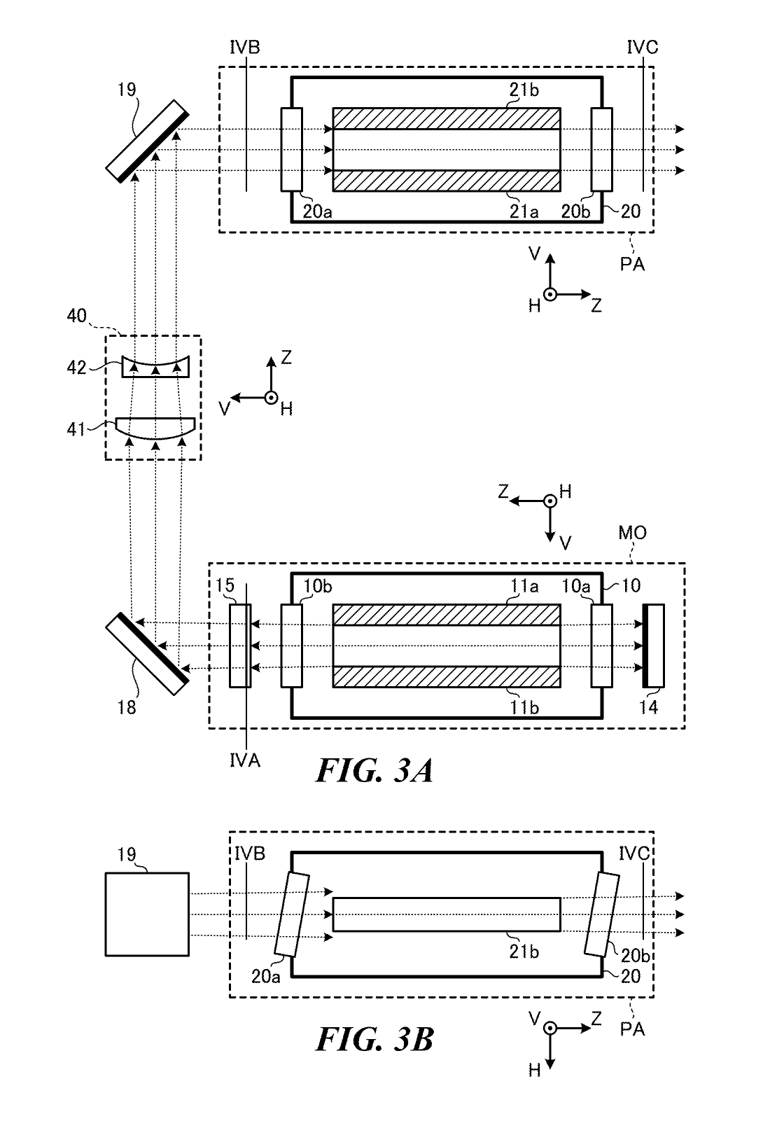

FIGS. 3A and 3B schematically show a configuration of a laser device according to a first embodiment of the present disclosure. The laser device of the first embodiment may include a beam-adjusting optical system 40 in the optical path of the laser beam between the high-reflective mirrors 18 and 19.

The beam-adjusting optical system 40 may be configured to adjust the beam width in the V direction of the laser beam entering the power amplifier PA to be substantially equal to the gap distance between the second pair of discharge electrodes 21a and 21b. The beam-adjusting optical system 40 may include, for example, a cylindrical convex lens 41 and a cylindrical concave lens 42.

### 3.2 OPERATION

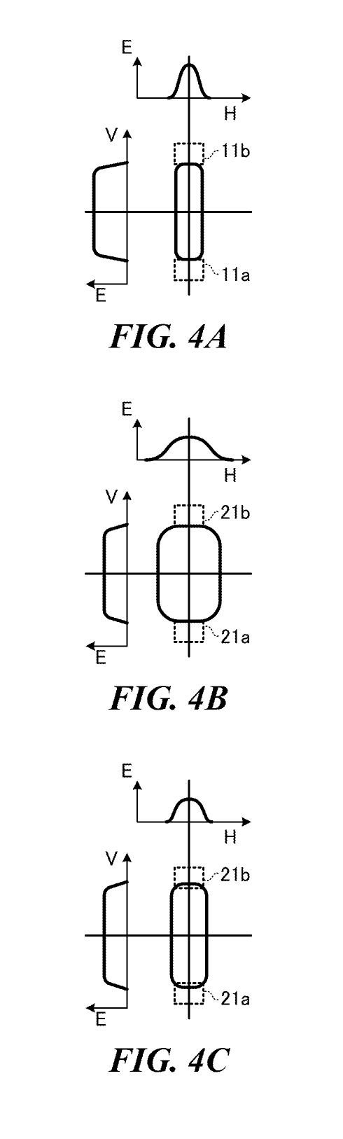

FIG. 4A shows a beam profile in a crass section of the laser beam at line IVA in FIG. 3A. FIG. 4B shows a beam profile in a cross section of the laser beam at line IVB in FIG. 3A. FIG. 4C shows a beam profile in a cross section of the laser beam at line IVC in FIG. 3A.

The laser beam outputted from the master oscillator MO may be reflected by the high-reflective mirror 16, and then enter the beam-adjusting optical system 40. The beam-adjusting optical system 40 may convert the beam profile of the laser beam such that the beam width in the V direction of the laser beam is substantially equal to the gap distance between the second pair of discharge electrodes 21a and 21b (see FIG. 4B).

The laser beam, converted such that the beam width in the V direction is substantially equal to the gap distance between the second pair of discharge electrodes 21a and 21b, may enter the discharge space between the second pair of discharge electrodes 21a and 21b.

### 3.3 EFFECT

The configuration explained above, as compared to the configuration without the beam-adjusting optical system 40, may suppress the problem where a part of the laser beam hits the second pair of discharge electrodes 21a and 21b and is wasted. The pulse energy of the pulsed laser beam outputted from the power amplifier PA may thus increase.

In the case where a part of the laser beam deviates in the ±H directions as shown in FIG. 4B, the part of the laser beam at each of the sides in the ±H directions may be wasted. However, the part of the laser beam at each of the sides in the ±H directions may have a relatively low light intensity. Therefore, energy to be wasted may not be so high.

### 3.4 OTHERS

The present embodiment shows an example where the beam-adjusting optical system 40 is provided in the optical path between the high-reflective mirrors 18 and 19. However, the present disclosure may not necessarily be limited to this example. At least a part of the beam-adjusting optical system 40 may be provided in the optical path between the output coupling mirror 15 and the high-reflective mirror 18 or the optical path between the high-reflective mirror 19 and the window 20a.

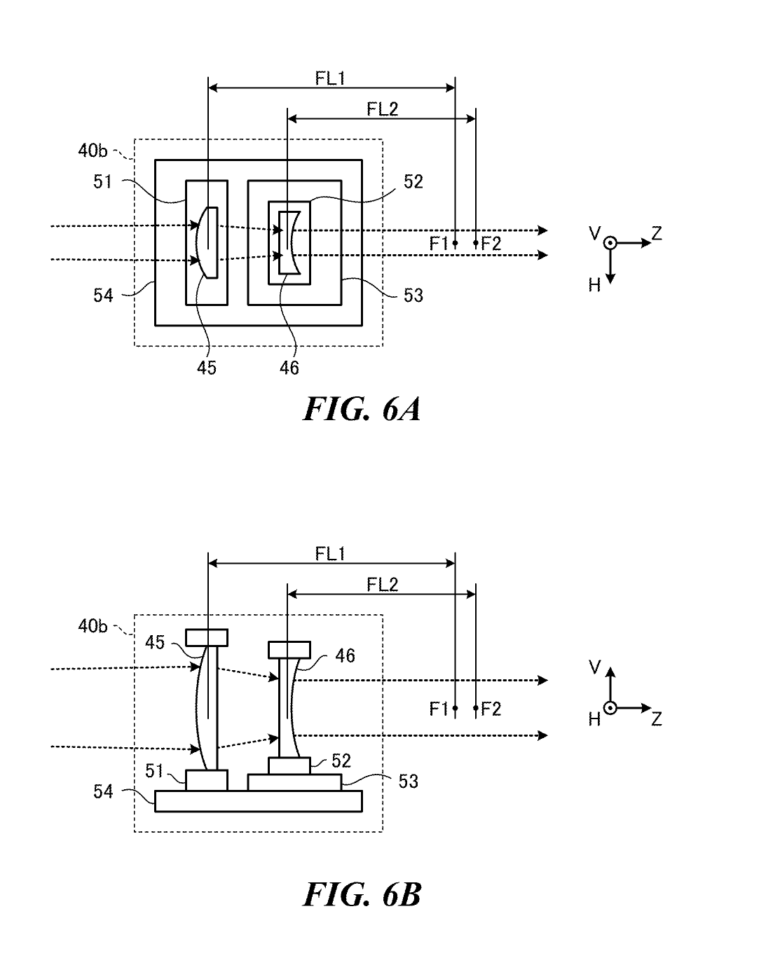

Further, the embodiment shows an example of the beam-adjusting optical system that functions to adjust the beam width in the V direction to be substantially equal to the gap distance between the second pair of discharge electrodes. However, the present disclosure may not necessarily be limited to adjusting the beam width in the V direction. As explained below with reference to FIGS. 6A, 6B, 7A, 7B, 8A, and 8B, the beam width in the H direction may also be adjusted substantially to the width of the discharge space in the H direction of the power amplifier PA.

### 3.5 FIRST EXAMPLE OF BEAM-ADJUSTING OPTICAL SYSTEM

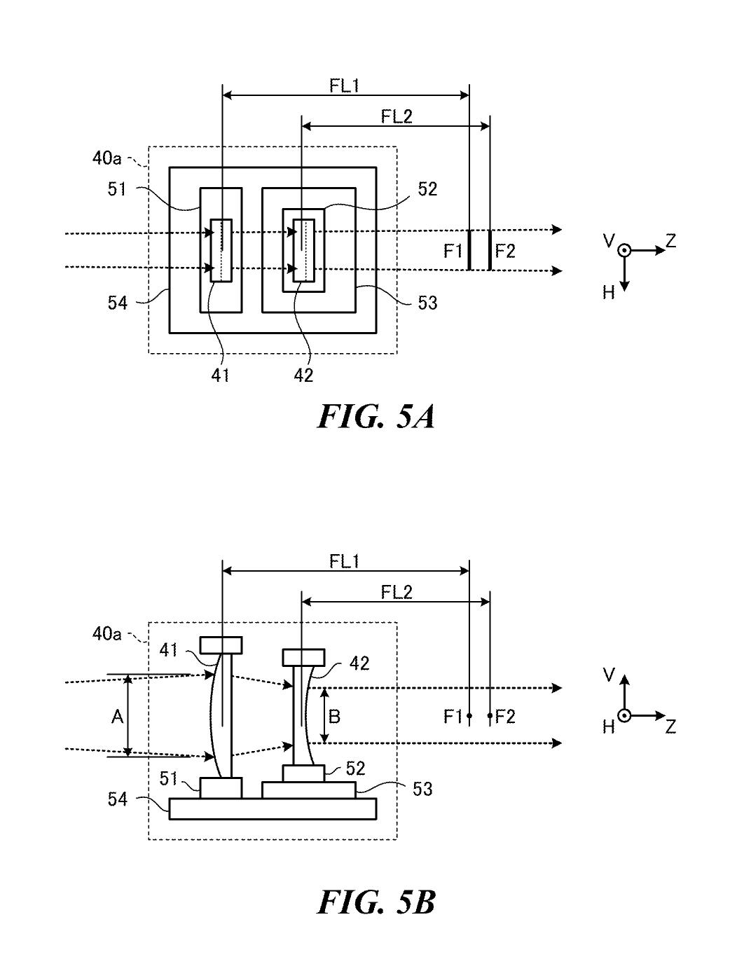

FIG. 5A shows a beam-adjusting optical system 40a as viewed in the −V direction. The beam-adjusting optical system 40a may represent a first example of the beam-adjusting optical system 40 according to the first embodiment shown in FIG. 3A. FIG. 5B shows the beam-adjusting optical system 40a as viewed in the −H direction.

The beam-adjusting optical system 40a may include a cylindrical convex lens 41 and a cylindrical concave lens 42. The cylindrical convex lens 41 and the cylindrical concave lens 42 may be provided in an optical path of the laser beam. The cylindrical convex lens 41 may be located upstream from the cylindrical concave lens 42 in the optical path of the laser beam.

The cylindrical convex lens 41 may have a rear-side focal axis F1 located downstream from the cylindrical convex lens 41 in the optical path of the laser beam at a distance corresponding to a focal length FL1. When parallel rays of light are transmitted by the cylindrical convex lens 41 from the left side in the figure, the rear-side focal axis F1 of the cylindrical convex lens 41 may be an axis corresponding to a line focus on which the rays of light are to be focused at the right side. An optical element such as the cylindrical convex lens 41 by which parallel rays of light are transmitted and focused or an optical element such as a concave mirror by which parallel rays of light are reflected and focused may be referred to as an optical element with a positive power.

The cylindrical concave lens 42 may have a front-side focal axis F2 located downstream from the cylindrical concave lens 42 in the optical path of the laser beam at a distance corresponding to a focal length FL2. When parallel rays of light are transmitted by the cylindrical concave lens 42 from the right side in the figure, the rays of light may diverge to the left side. The front-side focal axis F2 of the cylindrical concave lens 42 may be an axis corresponding to a line focus on which imaginary lines corresponding to the rays of light diverging to the left side are to cross each other at the right side. An optical element such as the cylindrical concave lens 42 by which parallel rays of light are transmitted and made diverge or an optical element such as a convex mirror by which parallel rays of light are reflected and made diverge may be referred to as an optical element with a negative power.

The focal length FL2 of the cylindrical concave lens 42 may be shorter than the focal length FL1 of the cylindrical convex lens 41. The rear-side focal axis F1 of the cylindrical convex lens 41 and the front-side focal axis F2 of the cylindrical concave lens 42 may each be substantially parallel to the H direction. The rear-side focal axis F1 of the cylindrical convex lens 41 and the front-side focal axis F2 of the cylindrical concave lens 42 may be located in the vicinity of each other. The front-side focal axis F2 of the cylindrical concave lens 42 may be located slightly downstream from the rear-side focal axis F1 of the cylindrical convex lens 41 in the optical path of the laser beam.

The cylindrical convex lens 41 may be held by a holder 51. The cylindrical concave lens 42 may be held by a holder 52. The holder 52, which holds the cylindrical concave lens 42, may be held by a uniaxial stage 53 and capable of moving along the optical path axis of the laser beam. The holder 51 and the uniaxial stage 53 may be held by a plate 54. This may allow the cylindrical concave lens 42 to move in a direction parallel to the Z direction along the optical path axis of the laser beam and to change distance from the cylindrical convex lens 41.

The uniaxial stage 53 may have a micrometer (not shown) to adjust the distance between the cylindrical convex lens 41 and the cylindrical concave lens 42 along the optical path axis of the laser beam. The micrometer may move the cylindrical concave lens 42 such that the beam width in the V direction of the laser beam becomes substantially equal to the gap distance between the second pair of discharge electrodes 21a and 21b. The micrometer may be a manually operated micrometer or an automatic micrometer. The automatic micrometer may be driven by a controller (not shown).

The pulsed laser beam outputted from the master oscillator MO, which may be a diverging beam gradually expanding its beam width, may be reflected by the high-reflective mirror 18 and may enter the cylindrical convex lens 41 of the beam-adjusting optical system 40a.

The laser beam incident on the cylindrical convex lens 41 as a diverging beam may be changed to a converging beam by the cylindrical convex lens 41. The converging beam gradually narrowing its beam width in the V direction may enter the cylindrical concave lens 42.

The front-side focal axis F2 of the cylindrical concave lens 42 may be located slightly downstream from the rear-side focal axis F1 of the cylindrical convex lens 41 in the optical path of the laser beam. In this configuration, the laser beam transmitted by the cylindrical concave lens 42 may be a nearly parallel beam.

The laser beam transmitted by the cylindrical concave lens 42 may become a laser beam having a beam width in the V direction substantially equal to the gap distance between the second pair of discharge electrodes 21a and 21b and then enter the power amplifier PA.

As shown in FIG. 5B, let A be the beam width in the V direction of the laser beam incident on the cylindrical convex lens 41 and let B be the beam width in the V direction of the laser beam transmitted by the cylindrical concave lens 42. It is preferable that the following formulae are satisfied:

B≈G, and

B/A≈FL2/FL1.

Here, G may be the gap distance between the second pair of discharge electrodes 21a and 21b. Based on the beam width A in the V direction of the laser beam incident on the cylindrical convex lens 41 and the gap distance G between the second pair of discharge electrodes 21a and 21b, the ratio FL2/FL1 of the focal lengths of the lenses may be determined and the beam width of the laser beam may be adjusted to a desirable value.

In this example, the rear-side focal axis F1 of the cylindrical convex lens 41 and the front-side focal axis F2 of the cylindrical concave lens 42 may each be substantially parallel to the H direction. However, the present disclosure may not necessarily be limited to this example.

For another example, the rear-side focal axis F1 of the cylindrical convex lens 41 and the front-side focal axis F2 of the cylindrical concave lens 42 may be arranged substantially parallel to the V direction. In that case, the distance between the cylindrical convex lens 41 and the cylindrical concave lens 42 may be adjusted such that the beam width in the H direction of the laser beam becomes substantially equal to the width of the discharge space of the power amplifier PA.

### 3.6 SECOND EXAMPLE OF BEAM-ADJUSTING OPTICAL SYSTEM

FIG. 6A shows a beam-adjusting optical system 40b as viewed in the −V direction. The beam-adjusting optical system 40b may represent a second example of the beam-adjusting optical system 40 according to the first embodiment shown in FIG. 3A. FIG. 6B shows the beam-adjusting optical system 40b as viewed in the −H direction.

The beam-adjusting optical system 40b may be different from the beam-adjusting optical system 40a described with reference to FIGS. 5A and 5B in that the cylindrical convex lens 41 is substituted by a spherical convex lens 45. Also, in the beam-adjusting optical system 40b, the cylindrical concave lens 42 may be substituted by a spherical concave lens 46.

The spherical convex lens 45 may have a rear-side focal point F1 located downstream from the spherical convex lens 45 in the optical path of the laser beam at a distance corresponding to a focal length FL1. When parallel rays of light are transmitted by the spherical convex lens 45 from the left side in the figure, the rear-side focal point F1 of the spherical convex lens 45 may be a point on which the rays of light are to be focused at the right side.

The spherical concave lens 46 may have a front-side focal point F2 located downstream from the spherical concave lens 46 in the optical path of the laser beam at a distance corresponding to a focal length FL2. When parallel rays of light are transmitted by the spherical concave lens 46 from the right side in the figure, the rays of light may diverge to the left side. The front-side focal point F2 of the spherical concave lens 46 may be a point on which imaginary lines corresponding to the rays of light diverging to the left side are to cross each other at the right side.

The rear-side focal point F1 of the spherical convex lens 45 and the front-side focal point F2 of the spherical concave lens 46 may be located in the vicinity of each other. The front-side focal point F2 of the spherical concave lens 46 may be located slightly downstream from the rear-side focal point F1 of the spherical convex lens 45 in the optical path of the laser beam.

The spherical convex lens 45 may be held by a holder 51. The spherical concave lens 46 may be held by a holder 52.

The configuration of holding the lenses and adjusting their positions may be substantially the same as that of the first example described with reference to FIGS. 5A and 5B.

The pulsed laser beam outputted from the master oscillator MO, which may be a diverging beam, gradually expanding its beam width, may be reflected by the high-reflective mirror 18 and then be incident on the spherical convex lens 45 of the beam-adjusting optical system 40a.

The laser beam incident on the spherical convex lens 45 as the diverging beam may be changed to a converging beam by the spherical convex lens 45. The converging beam gradually narrowing its beam widths both in the V direction and in the H direction may enter the spherical concave lens 46.

The front-side focal point F2 of the spherical concave lens 46 may be located slightly downstream from the rear-side focal point F1 of the spherical convex lens 45 in the optical path of the laser beam. In this configuration, the laser beam transmitted by the spherical concave lens 46 may be a nearly parallel beam.

The laser beam transmitted by the spherical concave lens 46 may be converted such that the beam width in the V direction is substantially equal to the gap distance between the second pair of discharge electrodes 21a and 21b or the beam width in the H direction is substantially equal to the width of the discharge space of the power amplifier PA and may enter the power amplifier PA.

The beam-adjusting optical system 40b may adjust the beam width in the V direction to be substantially equal to the gap distance between the second pair of discharge electrodes 21a and 21b, or adjust the beam width in the H direction to be substantially equal to the width of the discharge space of the power amplifier PA. Further, the beam-adjusting optical system 40b may set the distance between the lenses to a value between a distance where the beam width in the V direction is substantially equal to the gap distance between the second pair of discharge electrodes 21a and 21b and a distance where the beam width in the H direction is substantially equal to the width of the discharge space of the power amplifier PA.

According to the second example as explained above, the laser beam may enter the power amplifier PA with the reduced beam widths both in the V direction and in the H direction. Therefore, wasting a part of the laser beam may be suppressed, as compared to that in the first example. Further, pulse energy of the pulsed laser beam outputted from the power amplifier PA may thus increase.

### 3.7 THIRD EXAMPLE OF BEAM-ADJUSTING OPTICAL SYSTEM

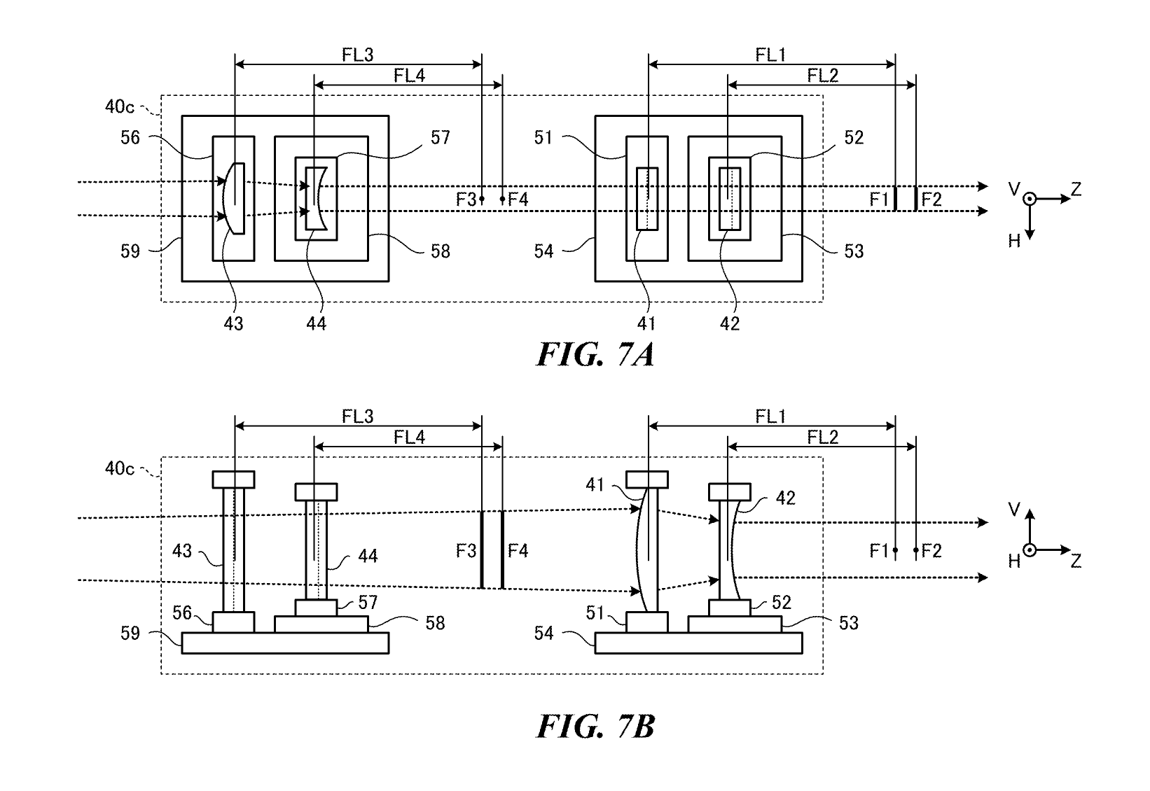

FIG. 7A shows a beam-adjusting optical system 40c as viewed in the −V direction. The beam-adjusting optical system 40c may represent a third example of the beam-adjusting optical system 40 according to the first embodiment shown in FIG. 3A. FIG. 7B shows the beam-adjusting optical system 40c as viewed in the −H direction.

The beam-adjusting optical system 40c may include a cylindrical convex lens 41 and a cylindrical concave lens 42. Configurations and operations of the cylindrical convex lens 41 and the cylindrical concave lens 42 may be substantially the same as those in the first example described with reference to FIGS. 5A and 5B.

The beam-adjusting optical system 40c may further include a cylindrical convex lens 43 and a cylindrical concave lens 44. Both the cylindrical convex lens 43 and the cylindrical concave lens 44 may be located in the optical path of the laser beam. The cylindrical convex lens 43 may be located upstream from the cylindrical concave lens 44 in the optical path of the laser beam.

The cylindrical convex lens 43 may have a rear-side focal axis F3 located downstream from the cylindrical convex lens 43 in the optical path of the laser beam at a distance corresponding to a focal length FL3.

The cylindrical concave lens 44 may have a front-side focal axis F4 located downstream from the cylindrical concave lens 44 in the optical path of the laser beam at a distance corresponding to a focal length FL4.

The rear-side focal axis F3 of the cylindrical convex lens 43 and the front-side focal axis F4 of the cylindrical concave lens 44 may each be substantially parallel to the V direction. The rear-side focal axis F3 of the cylindrical convex lens 43 and the front-side focal axis F4 of the cylindrical concave lens 44 may be located in the vicinity of each other. The front-side focal axis F4 of the cylindrical concave lens 44 may be located slightly downstream from the rear-side focal axis F3 of the cylindrical convex lens 43 in the optical path of the laser beam.

The cylindrical convex lens 43 may be held by a holder 56. The cylindrical concave lens 44 may be held by a holder 57. The holder 57, which holds the cylindrical concave lens 44, may be held by a uniaxial stage 58 and capable of moving along the optical path axis of the laser beam. The holder 55 and the uniaxial stage 58 may be held by a plate 59. This may allow the cylindrical concave lens 44 to move in a direction parallel to the Z direction along the optical path axis of the laser beam and to change distance from the cylindrical convex lens 43.

The uniaxial stage 58 may have a micrometer (not shown) to adjust the distance between the cylindrical convex lens 43 and the cylindrical concave lens 44 along the optical path axis of the laser beam.

In the above-described configuration, the distance between the cylindrical convex lens 41 and the cylindrical concave lens 42 may be adjusted such that the beam width in the V direction of the laser beam is substantially equal to the gap distance between the second pair of discharge electrodes 21a and 21b. Further, the distance between the cylindrical convex lens 43 and the cylindrical concave lens 44 may be adjusted such that the beam width in the H direction of the laser beam is substantially equal to the width of the discharge space of the power amplifier PA.

According to the third example as explained above, the beam widths of the laser beam may be controlled separately in the V direction and in the H direction. Therefore, wasting a part of the laser beam may further be suppressed, as compared to that in the first example or in the second example. Further, pulse energy of the pulsed laser beam outputted from the power amplifier PA may thus increase.

### 3.8 FOURTH EXAMPLE OF BEAM-ADJUSTING OPTICAL SYSTEM

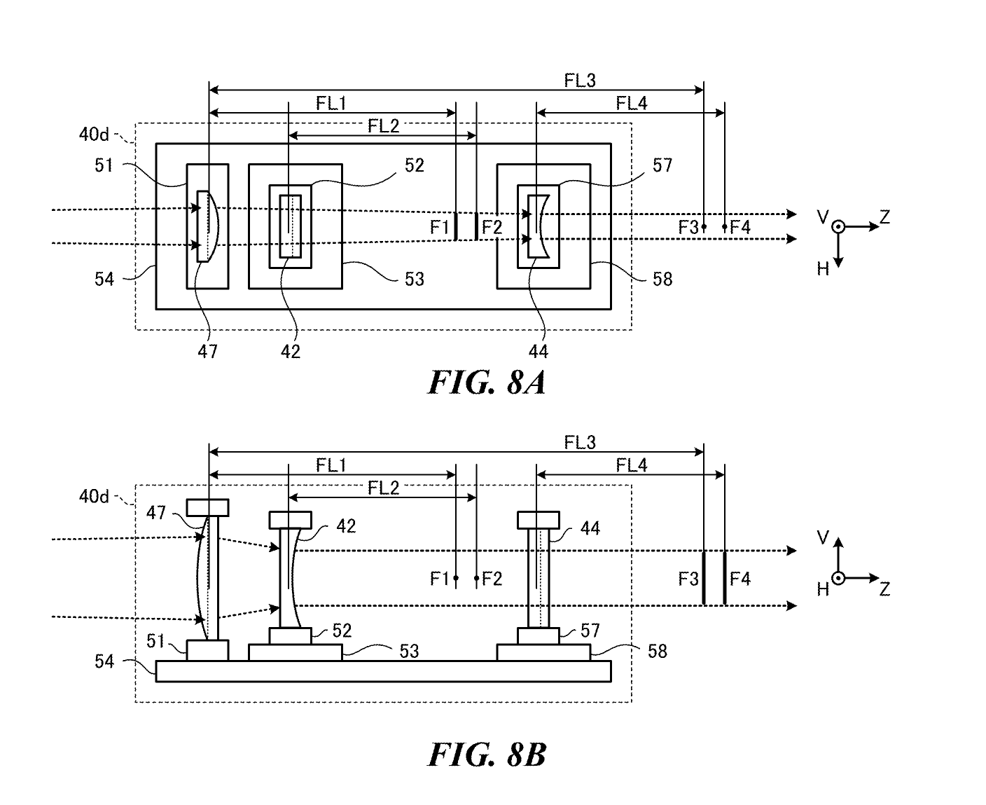

FIG. 8A shows a beam-adjusting optical system 40d as viewed in the −V direction. The beam-adjusting optical system 40d may represent a fourth example of the beam-adjusting optical system 40 according to the first embodiment shown in FIG. 3A. FIG. 8B shows the beam-adjusting optical system 40d as viewed in the −H direction.

In the fourth example, the two cylindrical convex lenses in the third example described with reference to FIGS. 7A and 7B may be substituted by a cylindrical biconvex lens.

The beam-adjusting optical system 40d may include a cylindrical biconvex lens 47, a cylindrical concave lens 42, and a cylindrical concave lens 44. These cylindrical lenses may be provided in the optical path of the laser beam. The cylindrical biconvex lens 47 may be located upstream from the cylindrical concave lens 42 and the cylindrical concave lens 44 in the optical path of the laser beam.

The cylindrical biconvex lens 47 may have a first cylindrical convex surface having an axis parallel to the H direction and a second cylindrical convex surface having an axis parallel to the V direction. The cylindrical biconvex lens 47 may have a rear-side focal axis F1 located downstream from the cylindrical biconvex lens 47 in the optical path of the laser beam at a distance corresponding to a focal length FL1. Further, the cylindrical biconvex lens 47 may have a rear-side focal axis F3 located downstream from the cylindrical biconvex lens 47 in the optical path of the laser beam at a distance corresponding to a focal length FL3.

The rear-side focal axis F1 of the cylindrical biconvex lens 47 and the front-side focal axis F2 of the cylindrical concave lens 42 may each be parallel to the H direction. The rear-side focal axis F1 of the cylindrical biconvex lens 47 and the front-side focal axis F2 of the cylindrical concave lens 42 may be located in the vicinity of each other. The front-side focal axis F2 of the cylindrical concave lens 42 may be located slightly downstream from the rear-side focal axis F1 of the cylindrical biconvex lens 47 in the optical path of the laser beam.

The rear-side focal axis F3 of the cylindrical biconvex lens 47 and the front-side focal axis F4 of the cylindrical concave lens 44 may each be substantially parallel to the V direction. The rear-side focal axis F3 of the cylindrical biconvex lens 47 and the front-side focal axis F4 of the cylindrical concave lens 44 may be located in the vicinity of each other. The front-side focal axis F4 of the cylindrical concave lens 44 may be located slightly downstream from the rear-side focal axis F3 of the cylindrical biconvex lens 47 in the optical path of the laser beam.

The cylindrical biconvex lens 47 may be held by a holder 51. The cylindrical concave lens 42 may be held by a holder 52. The cylindrical concave lens 44 may be held by a holder 57.

The configuration of holding the cylindrical biconvex lens 47, the cylindrical concave lens 42, and the cylindrical concave lens 44 and the configuration of adjusting their positions may be substantially the same as those described with reference to FIGS. 7A and 7B.

According to the above-described configurations, the distance between the cylindrical biconvex lens 47 and the cylindrical concave lens 42 may be adjusted such that the beam width of the laser beam in the V direction is substantially equal to the gap distance between the second pair of discharge electrodes 21a and 21b. Further, the distance between the cylindrical biconvex lens 47 and the cylindrical concave lens 44 may be adjusted such that the beam width of the laser beam in the H direction is substantially equal to the width of the discharge space of the power amplifier PA.

According to the fourth example described above, the beam widths of the laser beam may be controlled separately in the V direction and in the H direction. Further, according to the fourth example, the number of lenses may be reduced as compared to that in the third example and thus the configuration may be simplified.

### 3.9 FIFTH EXAMPLE OF BEAM-ADJUSTING OPTICAL SYSTEM

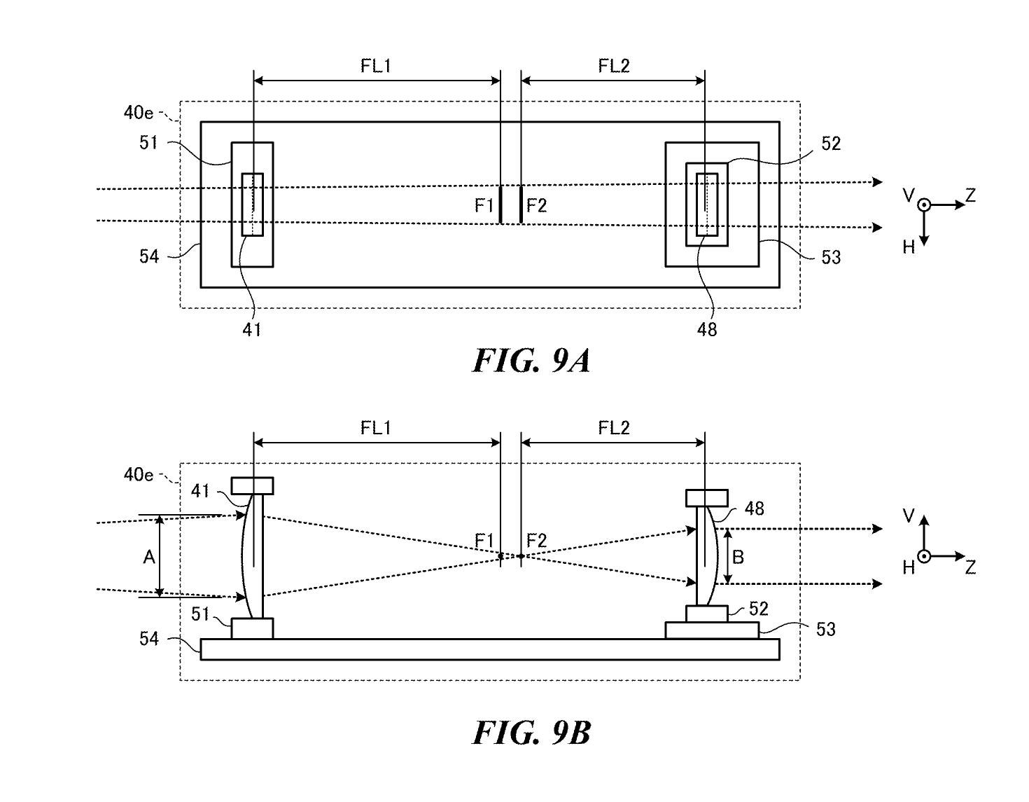

FIG. 9A shows a beam-adjusting optical system 40e as viewed in the −V direction. The beam-adjusting optical system 40e may represent a fifth example of the beam-adjusting optical system 40 according to the first embodiment shown in FIG. 3A. FIG. 9B shows the beam-adjusting optical system 40e as viewed in the −H direction.

In the fifth example, the cylindrical concave lens in the first example described with reference to FIGS. 5A and 5B may be substituted by a cylindrical convex lens, which is an optical element with a positive power.

The beam-adjusting optical system 40e may include a cylindrical convex lens 41 and a cylindrical convex lens 48. Both the cylindrical convex lens 41 and the cylindrical convex lens 48 may be located in the optical path of the laser beam. The cylindrical convex lens 41 may be located upstream from the cylindrical convex lens 48 in the optical path of the laser beam.

The cylindrical convex lens 41 may have a rear-side focal axis F1 located downstream from the cylindrical convex lens 41 in the optical path of the laser beam at a distance corresponding to a focal length FL1.

The cylindrical convex lens 48 may have a front-side focal axis F2 located upstream from the cylindrical convex lens 48 in the optical path of the laser beam at a distance corresponding to a focal length FL2. When parallel rays of light are transmitted by the cylindrical convex lens 48 from the right side in the figure, the front-side focal axis F2 of the cylindrical convex lens 48 may be an axis corresponding to a line focus on which the rays of light are to be focused at the left side.

The focal length FL2 of the cylindrical convex lens 48 may be shorter than the focal length FL1 of the cylindrical convex lens 41. The rear-side focal axis F1 of the cylindrical convex lens 41 and the front-side focal axis F2 of the cylindrical convex lens 48 may each be substantially parallel to the H direction. The rear-side focal axis F1 of the cylindrical convex lens 41 and the front-side focal axis F2 of the cylindrical convex lens 48 may be located in the vicinity of each other. The front-side focal axis F2 of the cylindrical convex lens 48 may be located slightly downstream from the rear-side focal axis F1 of the cylindrical convex lens 41 in the optical path of the laser beam.

The cylindrical convex lens 41 may be held by a holder 51. The cylindrical convex lens 48 may be held by a holder 52.

The configuration of holding the lenses and adjusting their positions may be substantially the same as that of the first example described with reference to FIGS. 5A and 5B.

The pulsed laser beam outputted from the master oscillator MO, which may be a diverging beam gradually expanding its beam width, may be reflected by the high-reflective mirror 18 and then be incident on the cylindrical convex lens 41 of the beam-adjusting optical system 40e.

The laser beam incident on the cylindrical convex lens 41 as the diverging beam may then be focused on a point located slightly downstream from the rear-side focal axis F1 of the cylindrical convex lens 41 in the optical path of the laser beam, then diverge, and then enter the cylindrical convex lens 48.

The front-side focal axis F2 of the cylindrical convex lens 48 may be located slightly downstream from the rear-side focal axis F1 of the cylindrical convex lens 41 in the optical path of the laser beam. In this configuration, the laser beam transmitted by the cylindrical convex lens 48 may be a nearly parallel beam.

The laser beam transmitted by the cylindrical convex lens 48 may be converted such that the beam width in the V direction is substantially equal to the gap distance between the second pair of discharge electrodes 21a and 21b and may enter the power amplifier PA.

As shown in FIG. 9B, let A be the beam width in the V direction of the laser beam incident on the cylindrical convex lens 41 and let B be the beam width in the V direction of the laser beam transmitted by the cylindrical convex lens 48. It is preferable that the following formulae are satisfied:

B≈G, and

B/A≈FL2/FL1.

Here, G may be the gap distance between the second pair of discharge electrodes 21a and 21b. Based on the beam width A in the V direction of the laser beam incident on the cylindrical convex lens 41 and the gap distance G between the second pair of discharge electrodes 21a and 21b, the ratio FL2/FL1 of the focal lengths of the lenses may be determined and the beam width of the laser beam may be adjusted to a desirable value.

In this example, the rear-side focal axis F1 of the cylindrical convex lens 41 and the front-side focal axis F2 of the cylindrical convex lens 48 may each be substantially parallel to the H direction. However, the present disclosure may not necessarily be limited to this example.

For another example, the rear-side focal axis F1 of the cylindrical convex lens 41 and the front-side focal axis F2 of the cylindrical convex lens 48 may be substantially parallel to the V direction.

Further, the spherical concave lens in the second example described with reference to FIGS. 6A and 6B may be substituted by a spherical convex lens. In this configuration, the front-side focal point F2 of the spherical convex lens, which replaces the spherical concave lens 46, may be located slightly downstream from the rear-side focal point F1 of the spherical convex lens 45 in the optical path of the laser beam.

Further, the cylindrical concave lenses in the third example described with reference to FIGS. 7A and 7B may be substituted by cylindrical convex lenses. In this configuration, the front-side focal axis F2 of one of the cylindrical convex lenses, which replaces the cylindrical concave lens 42, may be located slightly downstream from the rear-side focal axis F1 of the cylindrical convex lens 41 in the optical path of the laser beam. Further, the front-side focal axis F4 of another one of the cylindrical convex lenses, which replaces the cylindrical concave lens 44, may be located slightly downstream from the rear-side focal axis F3 of the cylindrical convex lens 43 in the optical path of the laser beam.

Furthermore, the cylindrical concave lenses in the fourth example described with reference to FIGS. 8A and 8B may be substituted by cylindrical convex lenses. Also in this configuration, the front-side focal axis F2 of one of the cylindrical convex lenses, which replaces the cylindrical concave lens 42, may be located slightly downstream from the rear-side focal axis F1 of the cylindrical biconvex lens 47 in the optical path of the laser beam. Further, the front-side focal axis F4 of another one of the cylindrical convex lenses, which replaces the cylindrical concave lens 44, may be located slightly downstream from the rear-side focal axis F3 of the cylindrical biconvex lens 47 in the optical path axis of the laser beam.

### 4. LASER DEVICE INCLUDING BOTH-SIDE TELECENTRIC BEAM-ADJUSTING OPTICAL SYSTEM

### 4.1 CONFIGURATION

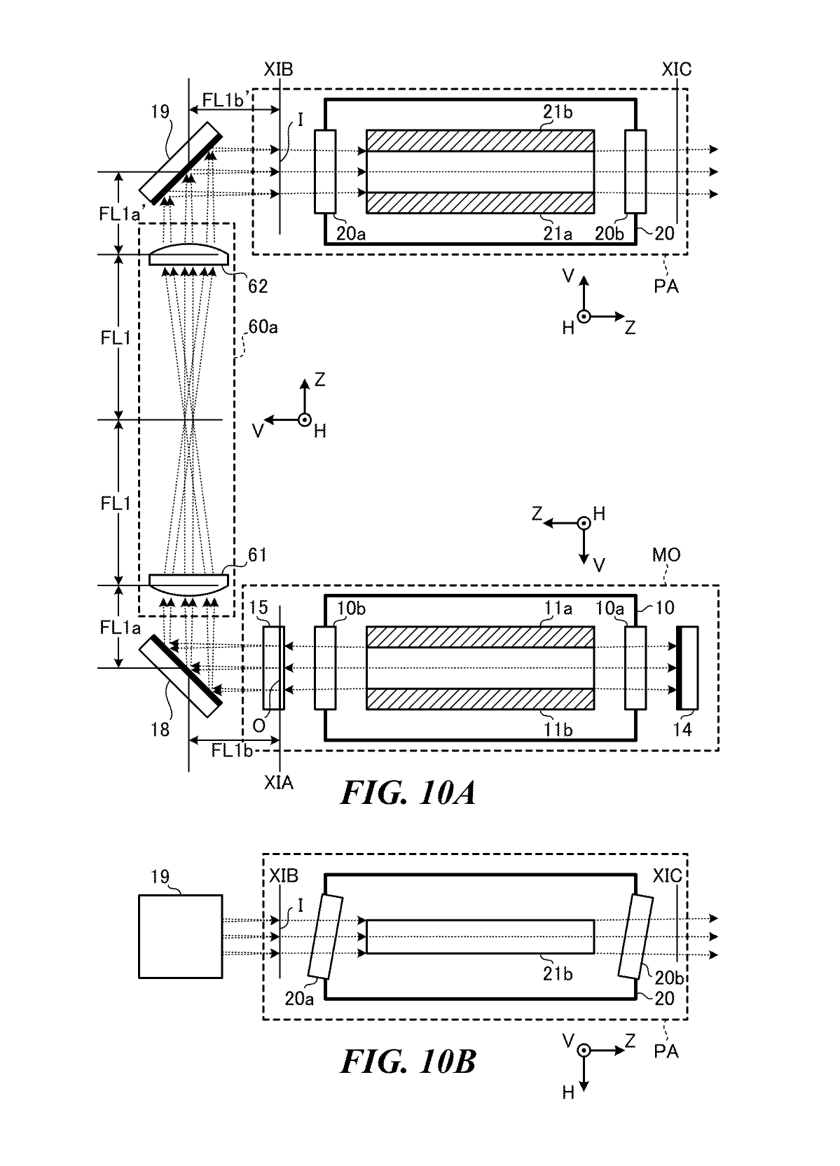

FIGS. 10A and 10B schematically show a configuration of a laser device according to a second embodiment of the present disclosure. The laser device of the second embodiment may include a beam-adjusting optical system 60a that is a both-side telecentric optical system. The beam-adjusting optical system 60a may be provided in the beam path of the laser beam between the high-reflective mirrors 18 and 19.

The beam-adjusting optical system 60a may include a spherical convex lens 61 and a spherical convex lens 62 each having a focal length FL1. Both the spherical convex lens 61 and the spherical convex lens 62 may be provided in the optical path of the laser beam.

The spherical convex lens 61 and the spherical convex lens 62 may be arranged such that the rear-side focal point of the spherical convex lens 61 and the front-side focal point of the spherical convex lens 62 substantially coincide with each other. Here, a hypothetical aperture may be disposed at a position where these focal points coincide with each other. Rays of light passing the center of the hypothetical aperture may be substantially parallel to the optical path axis of the laser beam in the optical path upstream from the spherical convex lens 61. Namely, an entrance pupil of the beam-adjusting optical system 60a may be located at infinity. Further, rays of light passing the center of the hypothetical aperture may be made substantially parallel to the optical path axis of the laser beam in the optical path downstream from the spherical convex lens 62. Namely, an exit pupil of the beam-adjusting optical system 60a may be located at infinity.

In addition, the partially-reflective surface of the output coupling mirror 15 may be positioned at the front-side focal point of the spherical convex lens 61. In FIG. 10A, a sum of the distance FL1a from the spherical convex lens 61 to the high-reflective mirror 18 and the distance FL1b from the high-reflective mirror 18 to the partially-reflective surface of the output coupling mirror 15 may be given by the following formula:

FL1a+FL1b=FL1.

Similarly, a sum of the distance FL1a′ from the spherical convex lens 62 to the high-reflective mirror 19 and the distance FL1b′ from the high-reflective mirror 19 to the rear-side focal point of the spherical convex lens 62 may also be FL1. In this configuration, an image of the partially-reflective surface of the output coupling mirror 15 may be formed at a position of the rear-side focal plane of the spherical convex lens 62 at a substantially equal magnification. Namely, an object plane O shown in FIG. 10A may be transferred at a magnification of 1:1 to an image plane I shown in FIG. 10A.

### 4.2 OPERATION

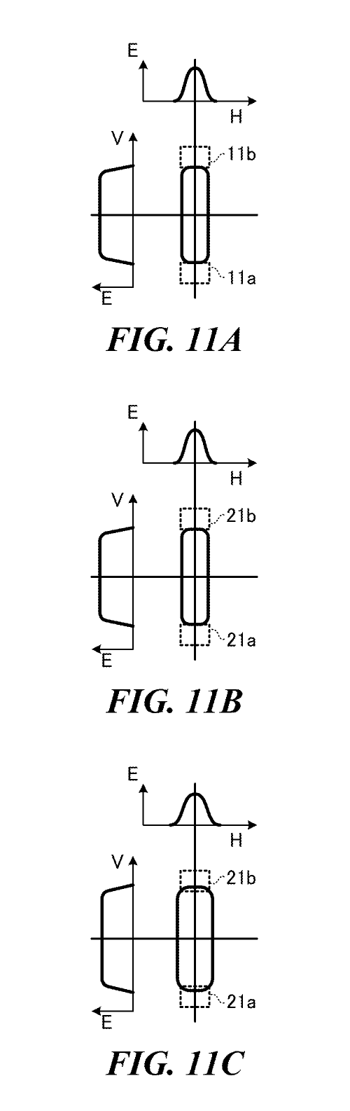

FIG. 11A shows a beam profile in a cross section of the laser beam at line XIA in FIG. 10A. FIG. 11B shows a beam profile in a cross section of the laser beam at line XIB in FIG. 10A. FIG. 11C shows a beam profile in a cross section of the laser beam at line XIC in FIG. 10A.

The laser beam outputted from the master oscillator MO may be reflected by the high-reflective mirrors 18 and 19, then pass the beam-adjusting optical system 60a, and then enter the power amplifier PA. The beam-adjusting optical system 60a may transfer the object plane O located at the partially-reflective surface of the output coupling mirror 15 of the master oscillator MO at a magnification of 1:1 to the image plane I located downstream from the beam-adjusting optical system 60a in the optical path of the laser beam. Therefore, the beam profile of the cross section of the beam shown in FIG. 11A and the beam profile of the cross section of the beam shown in FIG. 11B may be substantially equal to each other.

Further, the beam-adjusting optical system 60a may be a both-side telecentric optical system. According to this configuration, moving the object plane O along the optical path axis of the laser beam causes little change in the magnification. Further, moving the image plane I along the optical path axis of the laser beam also causes little change in the magnification.

### 4.3 EFFECT

According to the above-described configuration, the problem where a part of the laser beam does not enter the discharge space of the power amplifier PA to be wasted may be suppressed. The pulse energy of the pulsed laser beam outputted from the power amplifier PA may thus increase.

### 4.4 OTHERS

The present embodiment shows an example where the beam-adjusting optical system 60a is provided in the optical path between the high-reflective mirrors 18 and 19. However, the present disclosure may not necessarily be limited to this example. The beam-adjusting optical system 60a may be provided at any position in the optical path between the output coupling mirror 15 and the window 20a.

Further, explanation was made for an example where the focal length of the spherical convex lens 61 and the focal length of the spherical convex lens 62 may be substantially equal to each other. However, the present disclosure may not necessarily be limited to this example. The spherical convex lens 61 and the spherical convex lens 62 may have different focal lengths from each other according to a ratio of the gap distance between the first pair of discharge electrodes 11a and 11b to the gap distance between the second pair of discharge electrodes 21a and 21b.

Further, explanation was made for an example where the object plane O may be located in the partially-reflective surface of the output coupling mirror 15 and the image plane I may be located in the vicinity of the window 20a of the power amplifier PA. However, the present disclosure may not necessarily be limited to this example. The object plane O may be located in the optical resonator of the master oscillator MO. The object plane O may be located between the window 10a and the window 10b of the master oscillator MO. The image plane I may be located between the window 20a and the window 20b of the power amplifier PA. Preferably, the object plane O may be located between the first pair of discharge electrodes 11a and 11b and the image plane I may be located between the second pair of discharge electrodes 21a and 21b. More preferably, the object plane O may be located substantially at the center of the discharge space between the first pair of discharge electrodes 11a and 11b and the image plane I may be located substantially at the center of the discharge space between the second pair of discharge electrodes 21a and 21b.

### 4.5 MODIFIED EXAMPLE OF SECOND EMBODIMENT

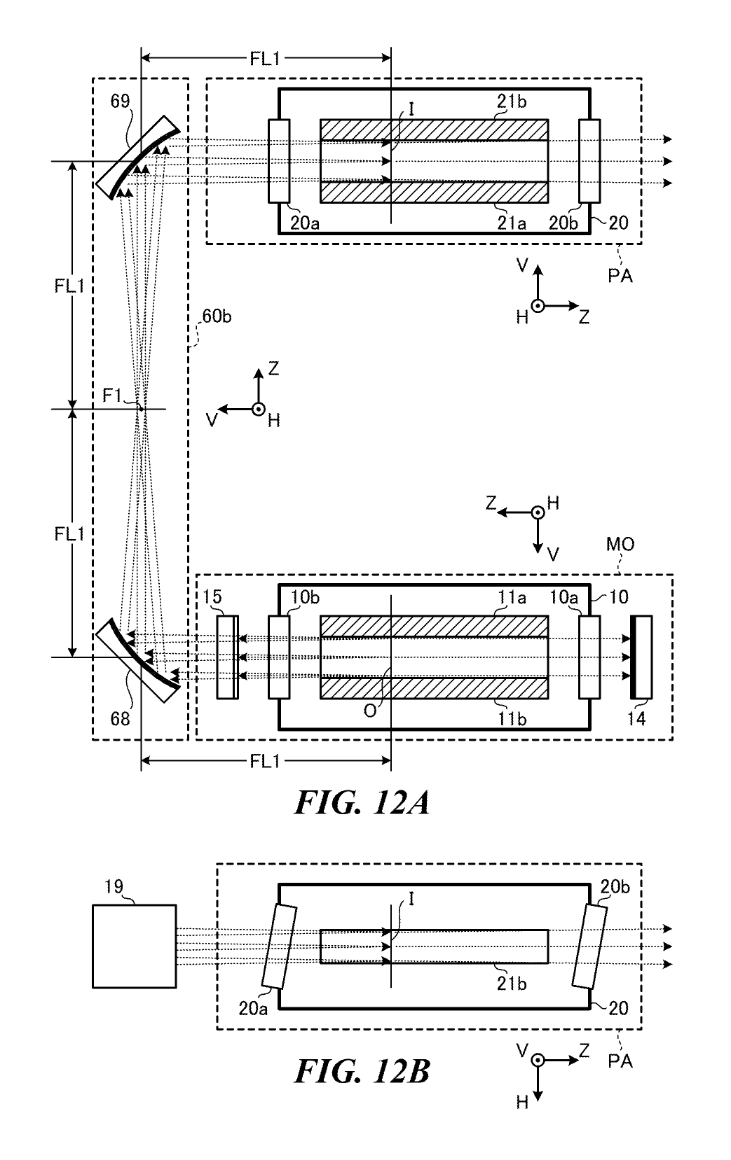

FIGS. 12A and 12B schematically show a configuration of a laser device of a modified example according to the second embodiment of the present disclosure. In this laser device, a beam-adjusting optical system 60b that is a both-side telecentric optical system may be configured by using two off-axis paraboloidal mirrors 68 and 69.

Both the off-axis paraboloidal mirror 68 and the off-axis paraboloidal mirror 69 may be located in the optical path of the laser beam. The off-axis paraboloidal mirror 68 may be located upstream from the off-axis paraboloidal mirror 69 in the optical path of the laser beam.

The off-axis paraboloidal mirror 68 and the off-axis paraboloidal mirror 69 may each be a mirror in which an inner surface of paraboloid of revolution is used for a reflective surface. The off-axis paraboloidal mirror 68 and the off-axis paraboloidal mirror 69 may be arranged such that the axes of the respective paraboloids of revolution are substantially parallel to each other and that the respective focal points F1 are substantially coincide with each other.

Parallel rays of the laser beam from the master oscillator MO may be incident on the off-axis paraboloidal mirror 66 in a direction parallel to the axis of the paraboloid of revolution. In this case, the off-axis paraboloidal mirror 68 may change the optical path axis of the laser beam by 90 degrees and focus the laser beam on a focal point F1.

A laser beam diverged from the focal point F1 may be incident on the off-axis paraboloidal mirror 69. In this case, the off-axis paraboloidal mirror 69 may change the optical path axis of the laser beam by 90 degrees and reflect the laser beam with parallel rays to the power amplifier PA in a direction parallel to the axis of the paraboloid of revolution. Practically, the laser beam may not necessarily include the parallel rays but may have some angle of divergence.

The focal lengths of the off-axis paraboloidal mirror 68 and the off-axis paraboloidal mirror 69 may be substantially equal to each other. In this configuration, an object plane O located upstream from the off-axis paraboloidal mirror 68 in the optical path of the laser beam at a distance corresponding to a focal length FL1 may be transferred at a magnification of 1:1 to an image plane I located downstream from the off-axis paraboloidal mirror 69 in the optical path of the laser beam at a distance corresponding to the focal length FL1. The object plane O may be located in the discharge space of the master oscillator MO. The image plane I may be located in the discharge space of the power amplifier PA.

This modified example may have substantially the same effect as that of the beam-adjusting optical system 60a described with reference to FIGS. 10A and 10B. Further, the beam-adjusting optical system 60b may have both functions of the high-reflective mirrors 18 and 19 and the beam-adjusting optical system 60a. Therefore, the number of optical elements may be reduced.

The off-axis paraboloidal mirror 68 and the off-axis paraboloidal mirror 69 may have different focal lengths from each other according to a ratio of the dimension of the discharge space of the master oscillator MO and the dimension of the discharge space of the power amplifier PA.

### 5. LASER DEVICE INCLUDING PLURALITY OF POWER AMPLIFIERS

### 5.1 CONFIGURATION

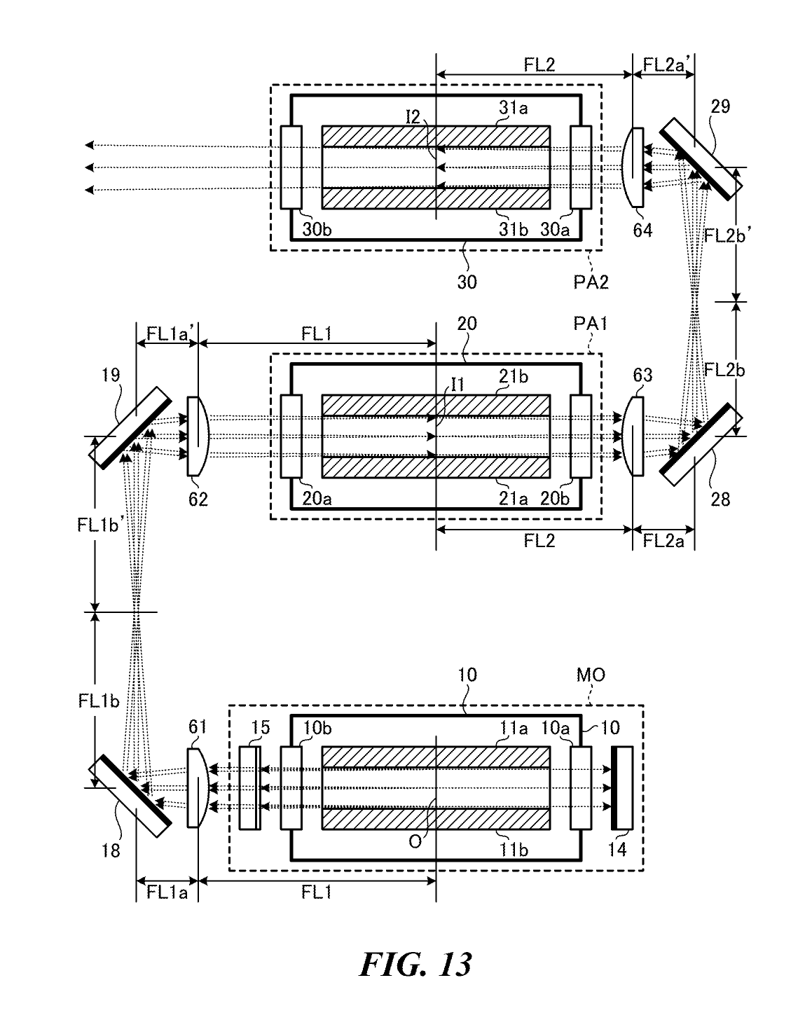

FIG. 13 schematically shows a configuration of a laser device according to a third embodiment of the present disclosure. The laser device of the third embodiment may include a first amplifier PA1 and a second amplifier PA2 as well as the master oscillator MO.

The configurations of the master oscillator MO and the first amplifier PA1 may be the same as the respective configurations of the master oscillator MO and the power amplifier PA described above. The second amplifier PA2 may include a third laser chamber 30 and a third pair of discharge electrodes 31a and 31b. The third pair of discharge electrodes 31a and 31b may be provided in the third laser chamber 30. The third laser chamber 30 may have windows 30a and 30b at respective ends of the third laser chamber 30. Specific configurations of the second amplifier PA2 may be substantially the same as those of the first amplifier PA1.

In the optical path of the laser beam between the master oscillator MO and the first amplifier PA1, optical elements such as the high-reflective mirrors 18 and 19, and in addition, a convex lens 61 and a convex lens 62 constituting a both-side telecentric beam-adjusting optical system may be disposed. The convex lens 61 and the convex lens 62 may each have a focal length FL1. In FIG. 13, sum of the distance FL1a from the convex lens 61 to the high-reflective mirror 18 and the distance FL1b from the high-reflective mirror 18 to the rear-side focal point of the convex lens 61 may be expressed by the following formula:

FL1a+FL1b=FL1.

Similarly, sum of the distance FL1b′ from the front-side focal point of the convex lens 62 to the high-reflective mirror 19 and the distance FL1a′ from the high-reflective mirror 1 to the convex lens 62 may also be FL1.

In the optical path of the laser beam between the first amplifier PA1 and the second amplifier PA2, optical elements such as high-reflective mirrors 28 and 29, and in addition, a convex lens 63 and a convex lens 64 constituting a both-side telecentric beam-adjusting optical system may be disposed. The convex lens 63 and the convex lens 64 may each have a focal length FL2. In FIG. 13, sum of the distance FL2a from the convex lens 63 to the high-reflective mirror 28 and the distance FL2b from the high-reflective mirror 28 to the rear-side focal point of the convex lens 63 may be represented by the following formula:

FL2a+FL2b=FL2.

Similarly, sum of the distance FL2b′ from the front-side focal point of the convex lens 64 to the high-reflective mirror 29 and the distance FL2a′ from the high-reflective mirror 29 to the convex lens 64 may also be FL2.

The focal length FL1 of each of the convex lens 61 and the convex lens 62 may be different from the focal length FL2 of each of the convex lens 63 and the convex lens 64.

### 5.2 OPERATION AND EFFECT

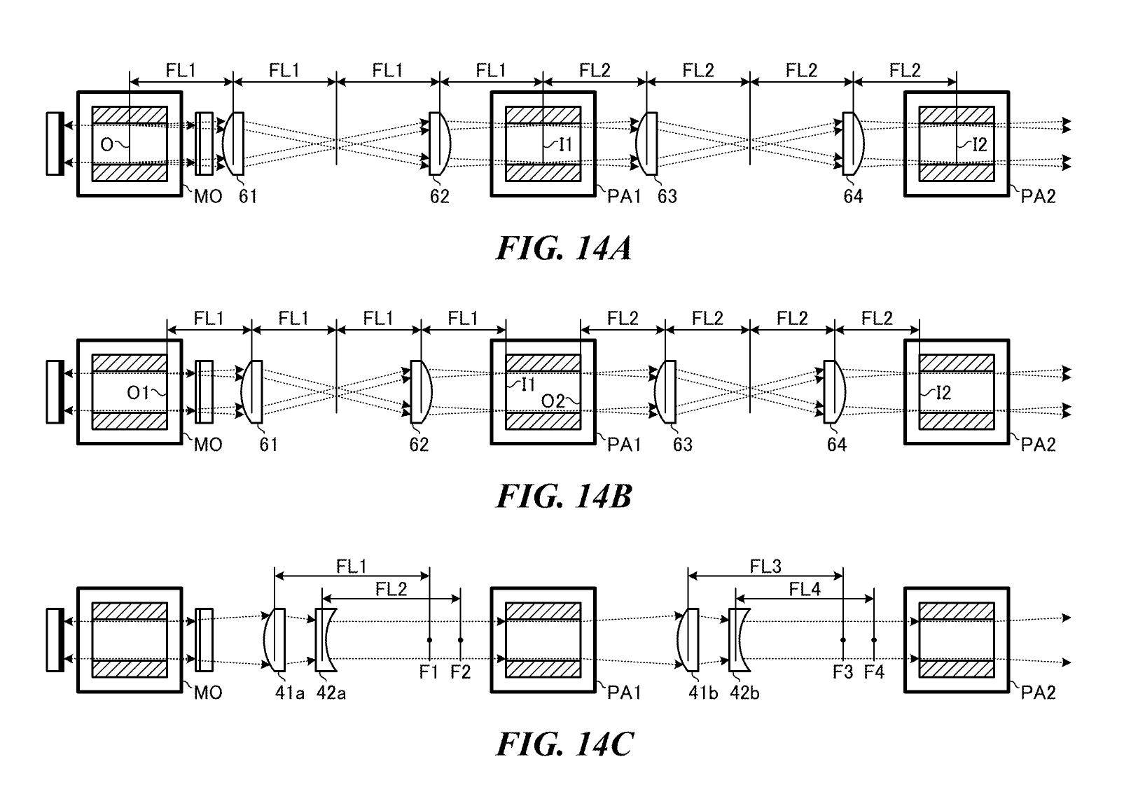

FIG. 14A schematically shows an optical arrangement of the laser device shown in FIG. 13.

The front-side focal point of the convex lens 61 may be located substantially at the center of the discharge space of the master oscillator MO. The rear-side focal point of the convex lens 62 may be located substantially at the center of the discharge space of the first amplifier PA1. According to this configuration, an object plane O located substantially at the center of the discharge space of the master oscillator MO may be transferred to a first image plane I1 located substantially at the center of the discharge space of the first amplifier PA1.

The front-side focal point of the convex lens 63 may be located substantially at the center of the discharge space of the first amplifier PA1. The rear-side focal point of the convex lens 64 may be located substantially at the center of the discharge space of the second amplifier PA2. According to this configuration, the first image plane I1 located substantially at the center of the discharge space of the first amplifier PA1 may be transferred to a second image plane 12 of the discharge space of the second amplifier PA2.

As explained above, the rear-side focal point of the convex lens 62 and the front-side focal point of the convex lens 63 may substantially coincide with each other. In this case, the object plane O located substantially at the center of the discharge space of the master oscillator MO may be transferred to the second image plane 12 located substantially at the center of the discharge space of the second amplifier PA2.

According to the above-described configuration, a part of the laser beam to be wasted may be reduced, the pulse energy of the pulsed laser beam outputted from the second amplifier PA2 may increase, and alignment of the optical paths from the master oscillator MO to the second amplifier PA2 may be improved.

### 5.3 MODIFIED EXAMPLES OF THIRD EMBODIMENT

FIG. 14B schematically shows an optical arrangement of a laser device of a first modified example according to the third embodiment of the present disclosure. In this laser device, a beam-adjusting optical system constituted by a convex lens 61 and a convex lens 62 may be both-side telecentric. The beam-adjusting optical system may have a first object plane O1 at a first end, which is close to the output coupling mirror, of the discharge space of the master oscillator MO. The beam-adjusting optical system may have a first image plane I1 at a first end, which is close to an entrance, of the discharge space of the first amplifier PA1. Further, a beam-adjusting optical system constituted by a convex lens 63 and a convex lens 64 may be both-side telecentric. The beam-adjusting optical system may have a second object plane O2 at a second end, which is close to an exit, of the discharge space of the first amplifier PA1. The beam-adjusting optical system may have a second image plane 12 at a first end, which is close to an entrance, of the discharge space of the second amplifier PA2.

FIG. 14C schematically shows an optical arrangement of a laser device of a second modified example according to the third embodiment of the present disclosure. In this laser device, a beam-adjusting optical system constituted by a convex lens 41a and a concave lens 42a may be provided between the master oscillator MO and the first amplifier PA1. Further, a beam-adjusting optical system constituted by a convex lens 41b and a concave lens 42b may be provided between the first amplifier PA1 and the second amplifier PA2.

The aforementioned descriptions are intended to be taken only as examples and are not to be seen as limiting in any way. Accordingly, it will be clear to those skilled in the art that variations on the embodiments of the present disclosure may be made without departing from the scope of the appended claims.

The terms used in the present specification and in the entirety of the scope of the appended claims are to be interpreted as not being limiting. For example, wording such as “includes” or “is included” should be interpreted as not being limited to the item that is described as being included. Furthermore, “has” should be interpreted as not being limited to the item that is described as being had. Furthermore, the modifier “a” or “an” as used in the present specification and the scope of the appended claims should be interpreted as meaning “at least one” or “one or more”.

1. A laser device comprising:
a master oscillator including a first laser chamber, a first pair of discharge electrodes provided in the first laser chamber, and an optical resonator, the master oscillator being configured to output a laser beam;
a first amplifier including a second laser chamber provided in an optical path of the laser beam outputted from the master oscillator and a second pair of discharge electrodes provided in the second laser chamber at a first gap distance, the first amplifier being configured to amplify the laser beam; and
a first beam-adjusting optical system provided in an optical path of the laser beam between the master oscillator and the first amplifier, the first beam-adjusting optical system being configured to adjust the laser beam outputted from the master oscillator such that a beam width of the laser beam entering the first amplifier measured in a direction of electric discharge between the second pair of discharge electrodes is substantially equal to the first gap distance between the second pair of discharge electrodes.

2. The laser device according to claim 1, wherein the first beam-adjusting optical system includes a first optical element with a positive power and a second optical element with a positive or negative power provided downstream from the first optical element in the optical path of the laser beam.

3. The laser device according to claim 2, wherein
the first optical element has a first focal length FL1,
the second optical element has a second focal length FL2 equal to or less than the first focal length FL1, and
a ratio B/A is expressed by a formula B/A≈FL2/FL1, where A represents a first beam width of the laser beam entering the first optical element, B represents a second beam width of the laser beam emitting from the second optical element, the first beam width A and the second beam width B are both in the direction of electric discharge between the second pair of discharge electrodes, and the second beam width B is substantially equal to the first gap distance between the second pair of discharge electrodes.

4. A laser device comprising:
a master oscillator including a first laser chamber, a first pair of discharge electrodes provided in the first laser chamber, and an optical resonator, the master oscillator being configured to output a laser beam;
a first amplifier including a second laser chamber provided in an optical path of the laser beam outputted from the master oscillator and a second pair of discharge electrodes provided in the second laser chamber, the first amplifier being configured to amplify the laser beam; and
a first beam-adjusting optical system provided in an optical path of the laser beam between the master oscillator and the first amplifier, the first beam-adjusting optical system being configured to adjust the laser beam outputted from the master oscillator, the first beam-adjusting optical system including a first optical element with a positive power and a second optical element with a positive or negative power provided downstream from the first optical element in the optical path of the laser beam.

5. The laser device according to claim 4, wherein
the first optical element has a first focal length FL1,
the second optical element has a second focal length FL2 equal to or less than the first focal length FL1, and
a front-side focal point of the second optical element is located slightly downstream from a rear-side focal point of the first optical element in the optical path of the laser beam.

6. A laser device comprising:
a master oscillator including a first laser chamber, a first pair of discharge electrodes provided in the first laser chamber, and an optical resonator, the master oscillator being configured to output a laser beam;
a first amplifier including a second laser chamber provided in an optical path of the laser beam outputted from the master oscillator and a second pair of discharge electrodes provided in the second laser chamber, the first amplifier being configured to amplify the laser beam; and
a first beam-adjusting optical system provided in an optical path of the laser beam between the master oscillator and the first amplifier, the first beam-adjusting optical system being a both-side telecentric optical system.

7. The laser device according to claim 6, wherein the first beam-adjusting optical system has a substantially equal magnification.

8. The laser device according to claim 6, wherein
an object point of the first beam-adjusting optical system is located in the optical resonator, and
an image point of the first beam-adjusting optical system is located between the second pair of discharge electrodes.

9. The laser device according to claim 6, wherein
an object point of the first beam-adjusting optical system is located substantially at a center of the optical resonator, and
an image point of the first beam-adjusting optical system is located substantially at a center of a space between the second pair of discharge electrodes.

10. The laser device according to claim 1, further comprising:
a second amplifier including a third laser chamber provided in an optical path of the, laser beam outputted from the first amplifier and a third pair of discharge electrodes provided in the third laser chamber at a second gap distance, the second amplifier being configured to amplify the laser beam outputted from the first amplifier; and
a second beam-adjusting optical system provided in an optical path of the laser beam between the first amplifier and the second amplifier, the second beam-adjusting optical system being configured to adjust the laser beam outputted from the first amplifier such that a beam width of the laser beam entering the second amplifier measured in a direction of electric discharge between the third pair of discharge electrodes is substantially equal to the second gap distance between the third pair of discharge electrodes.

11. The laser device according to claim 4, further comprising:
a second amplifier including a third laser chamber provided in an optical path of the laser beam outputted from the first amplifier and a third pair of discharge electrodes provided in the third laser chamber, the second amplifier being configured to amplify the laser beam outputted from the first amplifier; and
a second beam-adjusting optical system provided in an optical path of the laser beam between the first amplifier and the second amplifier, the second beam-adjusting optical system being configured to adjust the laser beam outputted from the first amplifier, the second beam-adjusting optical system including a third optical element with a positive power and a fourth optical element with a positive or negative power provided downstream from the third optical element in the optical path of the laser beam.

12. The laser device according to claim 6, further comprising:
a second amplifier including a third laser chamber provided in an optical path of the laser beam outputted from the first amplifier and a third pair of discharge electrodes provided in the third laser chamber, the second amplifier being configured to amplify the laser beam outputted from the first amplifier; and
a second beam-adjusting optical system provided in an optical path of the laser beam between the first amplifier and the second amplifier, the second beam-adjusting optical system being a both-side telecentric optical system.

13. The laser device according to claim 12, wherein
an object point of the first beam-adjusting optical system is located substantially at a center of the optical resonator,
an image point of the first beam-adjusting optical system and an object point of the second beam-adjusting optical system are both located substantially at a center of a space between the second pair of discharge electrodes, and
an image point of the second beam-adjusting optical system is located substantially at a center of a space between the third pair of discharge electrodes.

14. The laser device according to claim 1, wherein the first pair of discharge electrodes is provided in the first laser chamber at the first gap distance.
